(19) United States
(12) Patent Application Publication
(10) Pub. No.: US 2011/0106282 A1
(43) Pub. Date: May 5, 2011

(54) Audio Processing Utilizing a Dedicated CPU Core and a Real Time OS

(75) Inventors: Mark R. Craig, Lexington, KY (US); Michael W. Craig, Kansas City, MO (US); Timothy P. Craig, Georgetown, KY (US); Daniel C. Maggart, Georgetown, KY (US); Garon Rucker, Lexington, KY (US); Doug Anderson, Frankfort, KY (US)

(73) Assignee: COREVALUS SYSTEMS, LLC, Georgetown, KY (US)

(21) Appl. No.: 12/841,229

(22) Filed: Jul. 22, 2010

Related U.S. Application Data
(60) Provisional application No. 61/227,926, filed on Jul. 23, 2009.

(51) Int. Cl. G06F 9/46; G06F 17/00

(52) U.S. Cl. 700/94; 718/102

(57) ABSTRACT

This invention claims a novel software application that facilitates streaming and mixing audio and/or video with nearly zero latency, using a computer having Windows or Linux operating systems.

Typical computer operating systems are not structured sufficiently to transmit or receive audio and/or video data in a real time. Alternatively, Application Specific Integrated Circuits (ASICs) and Field Programmable Arrays (FPGAs} are used to transmit and receive audio and/or video data via the network. This requires extra hardware, space and cost.

The attributes of this invention are significant contributions to successful products in modern markets.

This application claims priority to and benefit of U.S. Provisional Patent Application Ser. No. 61/227,926 filed Jul. 23, 2009 entitled “Audio Processing Utilizing a Dedicated CPU Core and a Real Time OS.”

### FIELD OF THE INVENTION

This application describes a system using a computer to stream and mix audio/video signals in real time with low latency. The audio industry and video industry (is) are using standard IP networks to transmit data. Gigabit networks allow for over 250 channels of audio to be transmitted simultaneously. The network bandwidth is not an issue in current audio/video applications. However, the typical computer operating system is not architected well enough to transmit or receive audio or video data in a real time fashion. Typically Application Specific Integrated Circuits (ASICs) and Field Programmable Arrays (FPGAs} are used to transmit and receive audio/video data via the network. This requires extra hardware and cost. Usually, computers work well for streaming audio/video when timing is not critical and where buffers can be added to allow clean transmission of data. This invention describes a system where a standard computer can be used in a way to (maintain) retain the standard Windows environment and yet provide a real time transmission portal to the network for audio/video data.

### SUMMARY OF INVENTION

There are software applications that allow audio and video streaming. However, due to the multitasking architecture of most operating systems, it can take up to 10-50 ms to process network packets and make the data available to the user space. This potential delay requires a buffering structure that introduces +10 ms latency. For real-time audio applications where the musician depends on the system as feedback to their live performance, latencies of +10 ms cause problems. Standard streaming applications typically have very large buffers, which do not work for live environments. Multitasking architecture can also delay servicing hardware interrupt by switching between two buffers, this delay requires larger buffer sizes and thus, larger latencies.

There is at least one application where the software uses a dedicated computer to stream audio with low latency. Those systems utilize real time operating systems (non-Windows) and must be dedicated to the audio application. If the entire computer must be dedicated to the transmission and processing of the audio/video data, then there is no advantage compared to the ASIC or FPGA implementation.

### BRIEF DESCRIPTION OF DRAWINGS

Current Portable Computers (PCs) have Central Processing Units (CPUs) of extraordinary capabilities. These elements are functionally unique and are manipulated and controlled by software. Software is a combination of algorithms and flow diagrams well known by those skilled in the art. The multitude of combinations can be uniquely arranged to perform unique functions.

FIG. 1 is a block diagram depicting data paths between physical, system elements that are common to current PCs. Block 1 is a section of the CPU that can perform multiple, simultaneous functions such as sorting and directing data, as directed by specific operating codes.

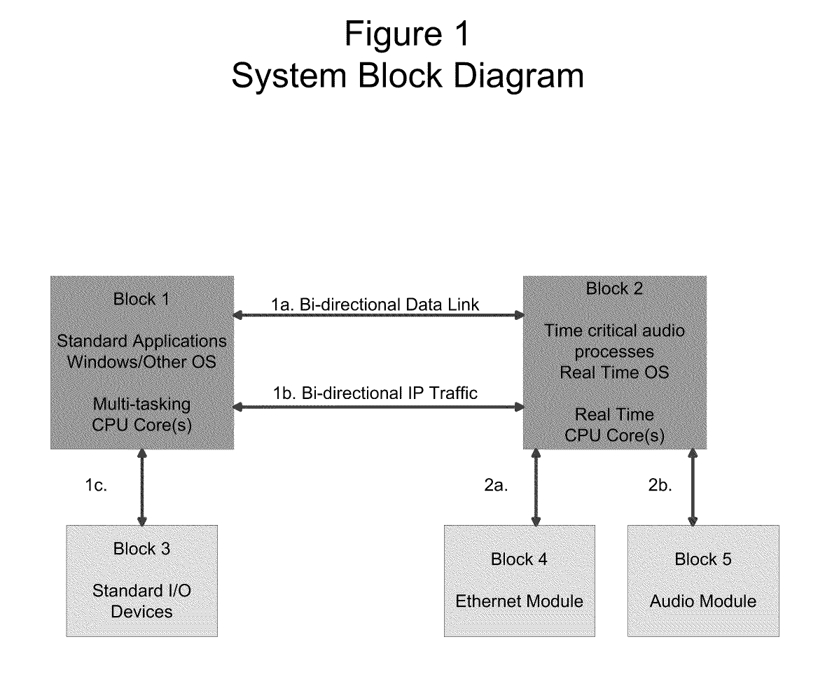

Block 2 manages content data in accordance to stored formats such as proper sequencing of incoming data to form images and sound on a television or computer. 1a and 1b are bi-directional data links between block 1 and block 2. These a standard CPU links as are 1c, 2a and 2b.

Block 3, standard Input/Output (I/O) devices, such as printers, computer displays, etc.

Block 4 is a standard computer Network Interface Controller.(NIC0 is herein considered to be a specialized integrated circuit function)

Block 5 is an audio module generally defined as a hardware device that facilitates the input and output of audio signals to and from a computer under control of computer programs.

### DETAILED DESCRIPTION OF PREFERRED EMBODIMENTS

This invention allows a standard multitasking operating system (ie. Windows or Linux) to run on a subset of the CPU cores, while dedicating a real time operating system to at least one of the cores of a Multi-Core Processor. A Multi-Core Processor refers to a CPU that includes multiple complete execution cores per physical processor. This allows standard user applications to run while maintaining the performance of real time on the same system. This arrangement allows the real time core to manage the Network Interface Controller (“NIC”) and the audio module. NIC is a hardware device that handles an interface to a computer network and allows a network-capable device to access that network. Controlling the NIC directly by RTOS allows network packets to be processed in real time. Controlling the audio module directly by RTOS allows short buffer lengths and time between hardware interrupts. The RTOS directs non-audio network traffic to the non-real time operating side of the system to run on a subset of the Central Processing Unit (CPU) cores, while dedicating a real time operating system to at least one of the cores of the processor. This allows standard user applications to run while maintaining the performance of real time on the same system. With this implementation the real time core manages the NIC and the audio module. The real time operating system passes non-audio network traffic over to the non-real time operating side of the system.

A computer can mix multiple audio channels into a single stereo mix with low latency by digitizing multiple channels of audio and transmitting the audio over standard IP networks and receiving the packets of audio through a standard Ethernet chip.

A user interface can be provided on the non-real time operating system to control the Audio/Video Processing on the RTOS.

What is claimed is:

1) The invention of a unique software control package, which is compatible with, and applicable to, standard computer operating systems whereby streaming audio and video occur with insignificant time delay.

2) The invention of claim 1 whereas one or more processor cores are dedicated to said audio and, or video processing whereby:
a) utilizing a Real Time Operating System (RTOS) on said dedicated core or cores for audio and, or video processing
b) utilizing a standard operating system such as Windows or Linux, on the remaining Central Processing Unit (CPU) cores.

3) The invention of claim 1 whereby the RTOS is functioning on said dedicated core, or cores, while simultaneously running a standard operating system such as Windows or Linux, on said remaining CPU cores.

4) The invention of claim 1 whereas controlling the Network Interface Controller (NIC) directly by the RTOS to allow network packets to be processed in real time.

5) The invention of claim 1 whereas Controlling the Audio Module directly by the RTOS to allow short buffer lengths and time between hardware interrupts.

6) The invention of claim 1 whereby using a computer to mix multiple audio channels into a single stereo mix with low latency by:
a) Digitizing multiple channels of audio and transmitting digitized audio over standard IP networks, or any other network protocol.
b) Receiving the packets of digitized audio through a standard NIC, or any other networking module.
c) Dedicating one or more processor cores to audio processing.
d) Utilizing a real time operating system on the dedicated core for audio/video processing
e) Running the RTOS on the dedicated core while simultaneously running a standard operating system, such as Windows or Linux, on the remaining CPU cores.
f) Controlling the NIC directly by the RTOS to allow network packets to be processed in real time.
g) Controlling the Audio Module directly by the RTOS to allow short buffer lengths and times between hardware interrupts.
h) Providing a user interface on the non-real time OS to control the Audio and/or Video Processing on the RTOS
i) Digitizing multiple channels of audio and transmitting digitized audio over standard IP networks.
j) Receiving the packets of digitized audio through a standard NIC, or any other networking module.
k) Dedicating one or more processor cores to audio processing.
l) Utilizing a real time operating system on the dedicated core for audio/video processing
m) Running the RTOS on the dedicated core while simultaneously running a standard operating system, such as. Windows or Linux, on the remaining CPU cores.
n) Controlling the NIC directly by the RTOS to allow network packets to be processed real time.
o) Controlling the Audio Module directly by the RTOS to allow short buffer lengths and times between hardware interrupts.
p) Providing a user interface on the non-real time OS to control the Audio and/or Video Processing on the RTOS
